(19) United States
(12) Patent Application Publication
(10) Pub. No.: US 2004/0253412 A1
(43) Pub. Date: Dec. 16, 2004

(54) Chairmat having gripping surface with interlocking ridges

(76) Inventor: Robert Cameron Dotson, Sparta, WI (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/463,351

(22) Filed: Jun. 16, 2003

(51) Int. Cl. B32B 7/00

(52) U.S. Cl. 428/119

(57) ABSTRACT

A chairmat having a gripping surface formed from a plurality of interlocking ridges extending from the bottom of the mat is disclosed. Each of the interlocking ridges may be configured so as to form a plurality of interlocking shapes, such as hexagons, rectangles, other polygons, or arcuate shapes. In so doing, not only is the mat provided with a mechanism by which the underlying surface can be gripped, but also is provided in a form which prevents the formation of any sharp edges on the bottom of the mat which would otherwise be negatively viewed by consumers and sales personnel.

### FIELD OF THE DISCLOSURE

The disclosure generally relates to floormats and, more particularly, relates to chairmats having floor gripping surfaces.

### BACKGROUND THW DISCLOSURE

Chairmats have become ubiquitous office supplies in the modern marketplace. Such mats are typically manufactured from relatively hard plastic to provide a smooth sturdy surface upon which to rest and roll a castered chair. The mats are often manufactured from clear or translucent plastic to enable the color or appearance of the underlying floor surface or carpet to be visible therethrough. Moreover, such mats typically include a gripping mechanism on a bottom surface to ensure that the mat stays relatively motionless and in place proximate the chair or workstation associated with the chair. Gripping mechanisms typically are provided in the form of prongs or hooks extending downwardly from the mat to provide a means by which the underlying carpet fibers can be gripped.

However, while such mats and gripping mechanisms have proven to be well received, they are not without drawbacks. More specifically, consumers, stock people, and any other people coming into contact with the mats often complain of, or are injured by, the relatively sharp hooks or other protrusions extending from the bottom of the mats. Even with those mats which purport to offer a “rounded” or otherwise unsharpened cleat or gripping mechanism, the molding process by which the mats are typically manufactured require a vent hole resulting in a relatively sharp nipple on the end of each cleat or gripping mechanism.

Moreover, currently employed cleats or gripping mechanisms can result in relatively weak areas in the mat itself in that they do not extend across the entire lateral or longitudinal dimension of the mats. Such weak spots can result in dents or cracks in the plastic after prolonged use due to the weight of the chair and user thereon.

### SUMMARY OF THE DISCLOSURE

In accordance with one aspect of the disclosure, a chairmat is disclosed which may comprise a planar member having a top surface and a bottom surface, and a gripping mechanism provided on the bottom surface of the planar member. The gripping mechanism may include a plurality of intersecting ridges which extend from the bottom surface.

In accordance with another aspect of the disclosure, a chairmat is disclosed which may comprise a planar member having a top surface, a bottom surface, and a horizontal plane, and a plurality of ridges integral with the planar member and extending orthogonally from the horizontal plane. Each of the ridges may be integrally connected and include a bottom, floor-engaging surface, with each floor-engaging surface being substantially free of any sharp edges.

In accordance with another aspect of the disclosure, a chairmat is disclosed which may include a planar member having a top surface, a bottom surface, and a plurality of side edges, and a plurality of ridges extending from the bottom surface. Each ridge may be continuous between at least two of the planar member side edges, the plurality of ridges forming a plurality of interconnected gripping mechanisms.

These and other aspects and features of the disclosure will become more apparent upon reading the following detailed description when taken in conjunction with the accompanying drawings.

### BRIEF DESCRIPTION OF THE DRAWINGS

FIG. 1 is an isometric view of a chairmat constructed in accordance with the teachings of the disclosure and depicted in a typical office environment;

FIG. 2 is a perspective cut away view of the bottom of the mat of FIG. 1;

FIG. 3 is a sectional view of the mat of FIG. 1, taken along the line 3-3 of FIG. 1;

FIG. 4 is a bottom plan view of an alternative embodiment of a mat constructed in accordance with the teachings of the disclosure;

FIG. 5 is a bottom plan view of a second alternative embodiment of a mat constructed in accordance with the teachings of the disclosure; and

FIG. 6 is a bottom plan view of a third alternative embodiment of a mat constructed in accordance with the teachings of the disclosure.

While the disclosure is susceptible to various modifications and alternative constructions, certain illustrative embodiments thereof have been shown in the drawings and will be described below in detail. It should be understood, however, that there is no intention to limit the disclosure to the specific forms disclosed, but on the contrary, the intention is to cover all modifications, alternative constructions, and equivalents falling within the spirit and scope of the invention as defined by the appended claims.

### DETAILED DESCRIPTION OF THE DISCLOSURE

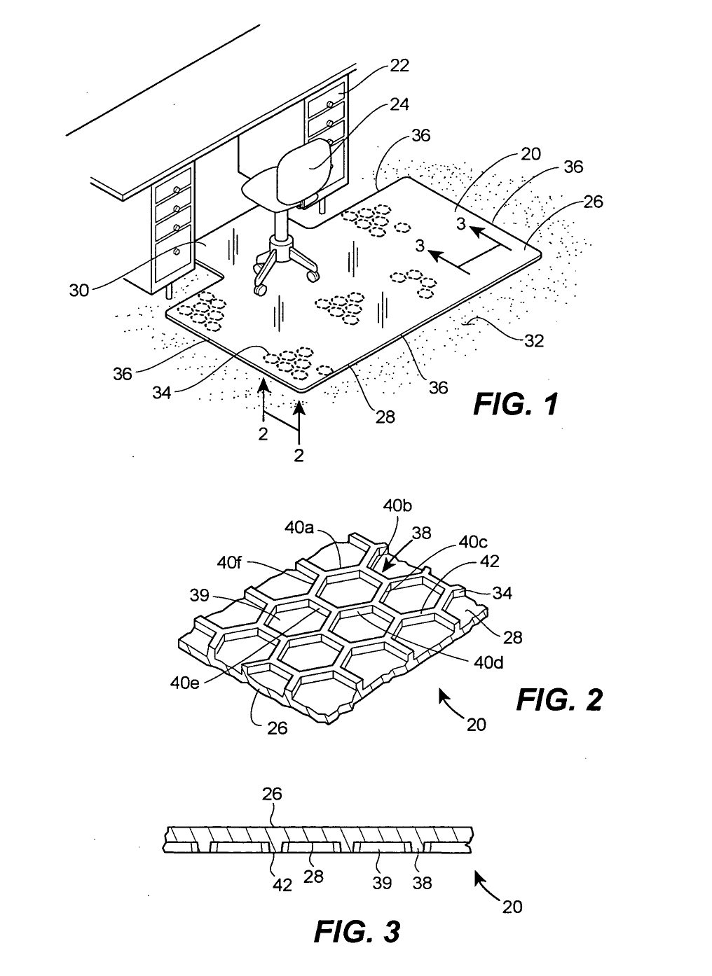

Referring now to the drawings, and with specific reference to FIG. 1, a chairmat constructed in accordance with the teachings of the disclosure is generally referred to by reference numeral 20. While the mat 20 is depicted and will be described below as a chairmat for use in conjunction with a desk 22, office chair 24, or the like, it is to be understood that the teachings of the disclosure can be used in conjunction with manufacturing any other type of relatively flat surface designed to be held in place on top of another surface as well. As a result, the technology disclosed herein can be used in conjunction with other apparatus, including, but not limited to, cutting boards, shelf liners, organizers, furniture bases, and the like.

Again referring to FIG. 1, the mat 20 is shown to include a planar member 25 having a top surface 26, as well as a bottom surface 28. In addition, while the mat 20 is shown to have a substantially rectangular overall configuration, it is to be understood that any other imaginable shape could be included and is encompassed within the teachings of this disclosure. For example, the mat 20 may be provided in the form of a circle, an ellipse, a triangle, a polygonal shape, or any other conceivable shape. Moreover, as depicted in FIG. 1, even when the mat 20 has a generally rectangular overall shape, one or more extensions 30 may be included to ensure coverage of an underlying surface or carpet 32 in oddly shaped environments.

As shown best in FIG. 2, the bottom surface 28 includes a plurality of ridges 34 which extend from the bottom surface 28. In the depicted embodiment, the ridges 34 extend from the bottom surface 28 in an orthogonal fashion, but it is to be understood that such ridges 34 could extend from the bottom surface 28 at angles other than 90° as well. FIG. 2 also depicts the ridges 34 being interconnected and extending to each of the edges 36 of the mat 20. In so doing, the rigidity of the mat 20 is greatly improved over mats 20 having no gripping surface, or those having a relatively small number of discrete or unconnected gripping surfaces, hooks, or prongs.

In the embodiment depicted in FIGS. 1-3, the ridges 34 are interconnected to form a plurality of interconnected hexagons 38, thereby forming an overall “honeycomb” appearance having a plurality of pockets 39 adapted to trap carpet fibers therein. Each of the hexagons 38 (except those along edges 36) share sides 40a-f with adjoining or abutting hexagons 38 across the bottom surface 28. Moreover, as shown best in FIG. 3, each of the ridges 34 forming each of the hexagons 38 is shown to include a bottom surface 42 which is substantially devoid of any sharp edges. In so doing, the aforementioned complaints, encountered by consumers and sales personnel handling prior art chairmats having sharp edges or gripping prongs, have been avoided.

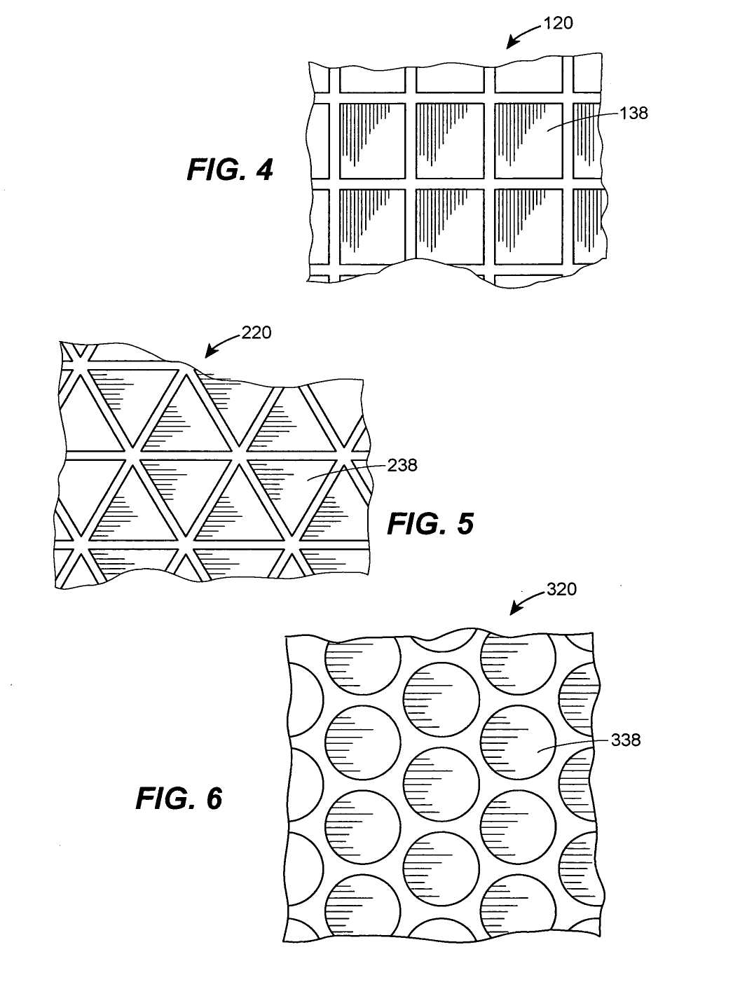

Referring now to FIGS. 4-6, three additional embodiments of mats constructed in accordance with the teachings of the disclosure are depicted. The mats of FIGS. 4-6 differ from the first embodiment of the mat 20 with regard to the shapes or forms created by the interlocking ridges 34. In all other aspects, the mats disclosed are the same and, in the interest of brevity, not described in repetitive fashion herein. For example, in the mat 120 of FIG. 4, it will be noted that the ridges 34 form a plurality of interlocking rectangles 138, while those of the embodiment depicted in FIG. 5 show a mat 220 having a plurality of interlocking triangles 238, and the embodiment of FIG. 6 shows a mat 320 having a plurality of interlocking circles 338. Similar to the first embodiment, each of the subsequent embodiments provide a gripping mechanism for the mat by providing, among other things, a closed structure which is adapted to trap carpet fibers within its confines.

From the foregoing, one of ordinary skill in the art will readily understand that the teachings of the disclosure can be used to manufacture a floormat having a gripping surface manufactured from a plurality of interlocking ridges extending from the bottom of the mat.

1. A chairmat, comprising:
a planar member having a top surface and a bottom surface; and
a gripping mechanism provided on the bottom surface, the gripping mechanism including a plurality of intersecting ridges extending from the bottom surface.

2. The chairmat of claim 1, wherein the plurality of intersecting lines form a plurality of interconnected hexagons.

3. The chairmat of claim 1, wherein the plurality of intersecting lines form a plurality of interconnected rectangles.

4. The chairmat of claim 1, wherein the plurality of intersecting lines form a plurality of interconnected triangles.

5. The chairmat of claim 1, wherein the plurality of intersecting lines form a plurality of interconnected circles.

6. The chairmat of claim 1, wherein the top surface is substantially smooth.

7. The chairmat of claim 1, wherein the plurality of ridges extend continuously between opposed side edges of the planar member.

8. A chairmat, comprising:
a planar member having a top surface and a bottom surface, the planar member defining a horizontal plane; and
a plurality of ridges integral with the planar member and extending orthogonally from the horizontal plane, each of the ridges being integrally connected and including a bottom, floor-engaging surface, the bottom, floor-engaging surface being substantially free of sharp edges.

9. The chairmat of claim 8, wherein the plurality of ridges form a plurality of interconnected hexagons.

10. The chairmat of claim 8, wherein the plurality of ridges form a plurality of interconnected rectangles.

11. The chairmat of claim 8, wherein the plurality of ridges form a plurality of interconnected triangles.

12. The chairmat of claim 8, wherein the plurality of ridges form a plurality of interconnected circles.

13. A chairmat, comprising:
a planar member having a top surface, a bottom surface, and a plurality of side edges; and
a plurality of ridges extending from the bottom surface, each ridge being continuous between at least two of the planar member side edges, the plurality of ridges forming a plurality of interconnected gripping mechanisms.

14. The chairmat of claim 13, wherein the gripping mechanisms are in the form of rectangles.

15. The chairmat of claim 13, wherein the gripping mechanisms are in the form of triangles.

16. The chairmat of claim 13, wherein the gripping mechanisms are in the form of circles.

17. The chairmat of claim 13, wherein the planar member is rectangular, and wherein ridges extend continuously across the planar member between opposed side edges.

18. The chairmat of claim 13, wherein the planar member and ridges are manufactured from a single unitary piece of molded plastic.

19. The chairmat of claim 18, wherein the plastic is transparent.

20. The chairmat of claim 13, wherein the ridges are at least as thick as the planar member.
